(19) United States
(12) Patent Application Publication
(10) Pub. No.: US 2004/0091716 A1
(43) Pub. Date: May 13, 2004

(54) Multilayer coating system comprising thiol-functional compounds

(75) Inventors: Keimpe Jan Van Den Berg, Sassenheim (NL); Edith Hulsbos, Woerden (NL); Frederik Rous, Amsterdam (NL); Hendrik Meijer, Hazerswoude-Dorp (NL); Judith Johanna Maria Adriana Werkman-Loenen, Hazerswoude-Dorp (NL)

Correspondence Address: OLIFF & BERRIDGE, PLC, P.O. BOX 19928, ALEXANDRIA, VA, 22320, US

(73) Assignee: AKZO NOBEL N.V., ARNHEM (NL)

(21) Appl. No.: 10/631,801

(22) Filed: Aug. 1, 2003

(30) Foreign Application Priority Data
Aug. 13, 2002 (EP) 02078356.9

(51) Int. Cl. B32B 27/06

(52) U.S. Cl. 428/422.8; 428/473.5; 428/500

(57) ABSTRACT

The invention relates to a multilayer coating system comprising

at least one layer a) comprising a coating composition a) comprising at least one resin and an effective number of thiol groups, and

at least one layer b) comprising a coating composition b) comprising at least one resin and an effective number of thiol-reactive groups,

at least one layer a) and at least one layer b) having at least one common layer boundary.

The invention further relates to the use of the above coating system in the finishing and refinishing of automobiles and large transportation vehicles and an aqueous coating composition comprising a thiol-containing polyurethane and a polyacrylate dispersion.

The invention relates to a multilayer coating system comprising at least one layer a) and at least one layer b), and to the use of the multilayer coating system.

Coating systems consisting of more than one layer, i.e. multilayer coating systems, are for example used in the coating of automobiles or other transport vehicles. To obtain a high gloss, a pigment-containing coating is provided with an unpigmented, so-called clear coat. This system is generally called a “base coat clear coat” system. In actual practice, the clear coat will be sprayed on the base coat, with or without prior curing of the base coat. The base coat and the clear coat may be water borne or solvent borne.

Other multilayer coating systems are for example the combination of a primer or a filler layer with a base coat or a top coat.

Multilayer coating systems are disclosed in EP-A-0 287 144, EP-A-0 632 076, WO 93/00377, WO 93/00380, and GB-A-2 171 030.

EP-A-0 287 144 discloses an aqueous base coat comprising a polyacrylic resin dispersion. The polyacrylic dispersion is a hydroxyl-functional resin. The base coat is used in combination with a commercially available clear coat.

EP-A-0 632 076 describes a process for preparing a multilayer coating. The base coat is obtained by curing of a water borne coating composition and the clear coat by curing of a solvent borne coating composition. The binder in the base coat is a combination of a physically drying polyurethane binder containing hydroxyl and acid groups and a polyisocyanate. The publication relates to the field of motorized vehicles, both in respect of the first coating and the refinishing thereof.

WO 93/00377, WO 93/00380, and GB-A-2 171 030 describe base coat/clear coat systems wherein the base coat is a water borne hydroxyl-functional polyacrylic dispersion and the clear coat comprises a resin with cross-linkable groups and a cross-linking agent such as a polyisocyanate in a volatile organic solvent. The base coat is cross-linked with the polyisocyanate in the clear coat. All three publications are in the field of car refinishes.

Multilayer coating systems based on a base coat in combination with a hydroxyl-reactive, more specifically isocyanate, group-containing clear coat composition often have a relatively low hardness.

Multilayer coating systems as described above frequently have an interlayer adhesion that is subject to improvement.

A further problem frequently encountered with multilayer coating systems is the formation of gas bubbles during drying, in particular when the coating layers are applied in relatively high layer thickness. This phenomenon is often referred to as popping.

The invention provides a multilayer coating system comprising

at least one layer a) comprising a coating composition a) comprising at least one resin and an effective number of thiol groups, and

at least-one layer b) comprising a coating composition b) comprising at least one resin and an effective number of thiol-reactive groups,

at least one layer-a) and at least one layer b) having at least one common layer boundary.

It has been found that when a multilayer coating system according to the invention is used, a significant increase in overall hardness and/or interlayer adhesion is achieved.

Contrary to the increased hardness of the multilayer system as described above, the hardness of layer a) comprising the thiol group-comprising coating composition a) as such may be lower than or equal to that of a layer comprising a coating composition comprising no thiol groups. Though applicant does not wish to be bound by any theory, the increase in hardness of the multilayer system is believed to be a result of the reaction between the thiol groups in coating composition a) and the thiol-reactive groups in coating composition b).

Also, the interlayer adhesion is believed to be the result of the reaction between the thiol groups in coating composition a) and the thiol-reactive groups in coating composition b).

Besides, the multilayer coating systems according to the invention are characterized by high gloss, good water resistance, good resistance to Chemicals, good adhesion, and little or no popping, even when applied in relatively high layer thickness. Defects in optical appearance of a multilayer coating, which are often encountered when using ultra high-solids coatings, can be reduced using the system according to the invention.

It should be noted that EP-A-0 794 204 discloses a latent curing aqueous dispersion comprising a polyurethane containing C═C bonds and a polyurethane or polyacrylate comprising thiol groups. The publication is aimed at the field of adhesives/glues. Although coatings are mentioned also, multilayer coating systems are not disclosed or suggested in this publication.

It should further be noted that EP-A-0 394 737 describes aqueous base coat compositions comprising an anionic polyurethane principal resin and an anionic polyacrylic grind resin. The polyurethane principal resin is the reaction product of i. a polyester component, ii. a multifunctional compound containing at least an active hydrogen and at least an active carboxylic acid functionality, iii. a compound having at least two active hydrogen groups (such as sulfhydryl) and iv. a polyisocyanate. Although in the preparation of the anionic polyurethane principal resin use is made of a sulfhydryl-comprising component, it is neither disclosed nor suggested that the resulting polyurethane principal resin comprises thiol groups.

Coating Composition a)

The Resin of Coating Composition a)

Coating composition a) in accordance with the invention can, in one embodiment, contain any resin normally used in coatings, such as polyaddition polymer, polyurethane, polyester, polyether, polyamide, polyurea, polyurethane-polyester, polyurethane-polyether, cellulose based binders, such as cellulose acetobutyrate, and/or hybrid resins, in combination with a compound with an effective number of thiol groups.

Polyaddition Polymer Resins of Coating Composition a)

As suitable polyaddition polymer resins may be mentioned the (co)polymers of ethylenically unsaturated monomers. The terms (meth)acrylate and (meth)-acrylic acid below refer to methacrylate and acrylate, as well as methacrylic acid and acrylic acid, respectively. Examples of suitable ethylenically unsaturated monomers are (meth)acrylic acid, methyl (meth)acrylate, ethyl (meth)acrylate, propyl (meth)acrylate, isopropyl (meth)acrylate, butyl (meth)acrylate, 2-ethyl-hexyl (meth)acrylate, octyl (meth)acrylate, isobornyl (meth)acrylate, dodecyl (meth)acrylate, cyclohexyl (meth)acrylate, other (meth)acrylic monomers such as 2-methoxyethyl (meth)acrylate, 2-ethoxyethyl (meth)acrylate, 3-methoxy-propyl (meth)acrylate; hydroxyalkyl (meth)acrylates, e.g. 2-hydroxyethyl (meth)acrylate, 2-hydroxypropyl (meth)acrylate, 4-hydroxybutyl (meth)acrylate, 6-hydroxyhexyl (meth)acrylate, p-hydroxycyclohexyl (meth)acrylate, hydroxy-polyethylene glycol (meth)acrylates, hydroxypolypropylene glycol (meth)acrylates, and the corresponding alkoxy derivatives thereof; epoxy (meth)acrylates, such as glycidyl (meth)acrylate; (meth)acrylamide, (meth)acrylonitrile, and N-methylol (meth)acrylamide; N-alkyl (meth)acrylamides, such as N-isopropyl (meth)acrylamide, N-t-butyl (meth)acrylamide, N-t-octyl (meth)acrylamide, N,N-dimethyl aminoethyl (meth)acrylate, and N,N-diethyl aminoethyl (meth)acrylate. These monomers may be used optionally in combination with comonomers such as mono- and diesters of maleate or fumarate, such as dibutyl maleate, dibutyl fumarate, 2-ethylhexyl maleate, 2-ethylhexyl fumarate, octyl maleate, isobornyl maleate, dodecyl maleate, cyclohexyl maleate, and the like, and/or with a vinyl derivative such as styrene, vinyl toluene, α-methyl styrene; vinyl naphthalene, vinyl chloride, vinyl acetate, vinyl pyrrolidone, vinyl laurate, vinylneododecanoate, N-vinyl formamide, and vinyl propionate, and/or with monomers containing one or more urea or urethane groups, for instance the reaction product of 1 mole of isocyanatoethyl methacrylate or α,α-dimethyl-isocyanatomethyl-3-isopropenyl benzene and 1 mole of butylamine, 1 mole of benzylamine, 1 mole of butanol, 1 mole of 2-ethylhexanol, and 1 mole of methanol, respectively. Mixtures of these monomers or adducts can also be used. Preferred (co)monomers are alkyl (meth)acrylates, such as methyl (meth)acrylate, ethyl (meth)acrylate, butyl (meth)acrylate, styrene, and mixtures thereof.

The polyaddition polymer can be prepared by conventional methods of free radical initiated polymerization. Alternatively, advanced polymerization techniques, such as group transfer polymerization (GTP), atom transfer radical polymerization (ATRP), and reversible addition fragmentation chain transfer (RAFT) polymerization, can also be used for the preparation of polyaddition polymer resins.

It is preferred that the polyaddition polymer resin is water borne. Such resins are suitably prepared by the generally known technique of aqueous emulsion polymerization. By emulsion polymerization is meant here the polymerization of monomer mixtures of ethylenically unsaturated monomers in water in the presence of a water-soluble or -insoluble initiator and 0.1-5 wt. % (calculated on the total monomer mixture(s)) of an emulsifier. The emulsion polymerization can be carried out as disclosed in EP-A-0 287 144 or GB-A-870 994.

Also preferred are core shell (meth)acrylate addition polymers. Such a core shell addition polymer includes a copolymer prepared in two or more steps by emulsion polymerization and obtained by copolymerization in a first step of 60-95 parts by weight (calculated on 100 parts by weight of the addition polymer) of a monomer mixture A consisting of 65-100 mole % of a mixture of 60-100 mole % of a (cyclo)alkyl (meth)acrylate of which the (cyclo)alkyl group contains 4-12 carbon atoms and 0-40 mole % of a di(cyclo)alkyl maleate and/or a di(cyclo)alkyl fumarate of which the (cyclo)alkyl groups contain 4-12 carbon atoms, and 0-35 mole % of a different, copolymerizable, monoethylenically unsaturated monomer, and by copolymerization in a subsequent step of 5-40 parts by weight (calculated on 100 parts by weight of the addition polymer) of a monomer mixture B of 10-60 mole % of (meth)acrylic acid and 40-90 mole % of a different, copolymerizable, monoethylenically unsaturated monomer, with the carboxylic acid groups derived from the (meth)acrylic acid being at least partially ionized. Preferably, the addition polymer is obtained by copolymerization of 80-90 parts by weight of monomer mixture A and 10-20 parts by weight of monomer mixture B (both amounts being calculated on 100 parts by weight of the addition polymer). Preferably, this monomer mixture A should contain 70-95, more particularly 80-95 mole % of the aforementioned (cyclo)alkyl (meth)acrylate. More preferably, maximally 35, and preferably 5-20 mole % of suitable monomeric, monoethylenically unsaturated compounds will be used in monomer mixture A. It is preferred that monomer mixture B should contain 15-50, more particularly 2040 mole % of (meth)acrylic acid and 50-85, more particularly 60-80 mole % of the different, copolymerizable, ethylenically unsaturated monomer. Copolymerization of monomer mixture B will generally yield a copolymer having an acid number of 30-450 and preferably of 60-350, and a hydroxyl number of 0450 and preferably of 60-300. Both the acid number and the hydroxyl number are expressed in mg of KOH per g of copolymer. Optionally, different monomer mixtures A and/or B may be used successively. Preferably, the core-shell addition polymer is not a cross-linked particle. For examples of suitable (meth)acrylic monomers reference is made to the ones mentioned above. Core-shell poly(meth)acrylates are described in more detail in EP-A-0 287 144 and WO 99/67339.

It is also suitable to prepare water borne polyaddition polymer resins by a two-step process. In the first step the polyaddition polymer resin is prepared by the polymerization of suitable ethylenically unsaturated monomers as described above in an essentially non-aqueous environment, optionally in the presence of an organic solvent. In the second step of said two-step process mixing the polyaddition polymer resin with an aqueous medium can be done conveniently by adding water to the polyaddition polymer or, alternatively, by adding the polyaddition polymer to water, under agitation.

Use may be made of external emulsifiers. Suitable emulsifiers include anionic emulsifiers, such as carboxylate-, sulphonate-, and phosphonate-containing compounds, cationic emulsifiers such as amine/ammonium groups, and non-ionic emulsifiers based on alkylene oxide groups. The preferred alkylene oxide groups are ethylene oxide groups, but alternatively propylene oxide groups or mixtures of ethylene oxide and propylene oxide groups are useful as well. For example, the alkylene oxide groups can be C₁-C₄ alkoxy ethers of polyalkylene glycols with the structure:

—O—[—CH₂—CHR²—O]ₓ—R¹

wherein R¹ is a hydrocarbon radical with 1 to 4, preferably 1 or 2, carbon atoms; R² is a H atom or a methyl group; x is between 2 and 50, preferably between 2 and 25. The distribution of the alkylene glycols may be random, alternating or blocked. Examples are C₁-C₄ alkoxy polyC₂(C₃)alkylene oxide glycol and/or C₁-C₄ alkoxy polyC₂(C₃)alkylene oxide 1,3-diol, wherein polyC₂(C₃) alkylene oxide stands for polyethylene oxide, optionally comprising propylene oxide units. The organic solvent content of the resulting emulsion or dispersion can be reduced by distillation, optionally under reduced pressure.

Polyurethane Resins of Coating Composition a)

Suitable resins for coating composition a) according to the invention are polyurethanes. Polyurethanes can be prepared according to generally known methods by reacting

a) an organic polyisocyanate,

b) one or more polyalcohols selected from

b1) polyalcohols containing 2 to 6 hydroxyl groups and having a number average molecular weight up to 400 and

b2) polymeric polyols having a number average molecular weight between about 400 and about 3,000,

c) optionally compounds containing at least two isocyanate-reactive groups, such as diamines or dithiols,

d) optionally compounds having ionic and/or non-ionic stabilizing groups, and

e) optionally compounds having one isocyanate-reactive group.

The polyurethane can be prepared in a conventional manner by reacting a stoichiometric amount or an excess of the organic polyisocyanate with the other reactants under substantially anhydrous conditions at a temperature between about 30° C. and about 130° C. until the reaction between the isocyanate groups and the isocyanate-reactive groups is substantially complete. The reactants are generally used in proportions corresponding to a ratio of isocyanate groups to isocyanate-reactive (usually hydroxyl) groups of from about 1:1 to about 6:1, preferably about 1:1. If an excess of the organic polyisocyanate is used, an isocyanate-terminated prepolymer can be prepared in a first step. In a second step, at least one isocyanate-reactive group containing compound c), can be added.

The organic polyisocyanate a) used in making the polyurethane resin can be an aliphatic, cycloaliphatic or aromatic di-, tri- or tetra-isocyanate that may be ethylenically unsaturated or not. Examples of diisocyanates include 1,2-propylene diisocyanate, trimethylene diisocyanate, tetramethylene diisocyanate, 2,3-butylene diisocyanate, hexamethylene diisocyanate, octamethylene diisocyanate, 2,2,4-trimethyl hexamethylene diisocyanate, dodecamethylene diisocyanate, , ω,ω′-dipropylether diisocyanate, 1,3-cyclopentane diisocyanate, 1,2-cyclohexane diisocyanate, 1,4-cyclohexane diisocyanate, isophorone diisocyanate, 4-methyl-1,3-diisocyanatocyclohexane, trans-vinylidene diisocyanate, dicyclohexyl methane-4,4′-diisocyanate (Desmodur® W), toluene diisocyanate, 1,3-bis(isocyanatomethyl) benzene, xylylene diisocyanate, α,α,α′,α′-tetramethyl xylylene diisocyanate (TMXDI®), 1,5-dimethyl-2,4-bis(2-isocyanatoethyl) benzene, 1,3,5-triethyl-2,4-bis(isocyanatomethyl) benzene, 4,4′-diisocyanato-diphenyl, 3,3′-dichloro-4,4′-diisocyanato-diphenyl, 3,3′-diphenyl-4,4′-diisocyanato-diphenyl, 3,3′-dimethoxy-4,4′-diisocyanato-diphenyl, 4,4′-diisocyanato-diphenyl methane, 3,3′-dimethyl-4,4′-diisocyanato-diphenyl-methane, and diisocyanatonaphthalene. Examples of triisocyanates include 1,3,5-triisocyanatobenzene, 2,4,6-triisocyanatotoluene, 1,8-diisocyanato-4-(isocyanatomethyl) octane, and lysine triisocyanate. Adducts and oligomers of polyisocyanates, for instance, biurets, isocyanurates, allophanates, uretdiones, urethanes, and mixtures thereof are also included. Examples of such oligomers and adducts are the adduct of 2 molecules of a diisocyanate, for example hexamethylene diisocyanate or isophorone diisocyanate, to a diol such as ethylene glycol, the adduct of 3 molecules of hexamethylene diisocyanate to 1 molecule of water (available under the trademark Desmodur N of Bayer), the adduct of 1 molecule of trimethylol propane to 3 molecules of toluene diisocyanate (available under the trademark Desmodur L of Bayer), the adduct of 1 molecule of trimethylol propane to 3 molecules of isophorone diisocyanate, the adduct of 1 molecule of pentaerythritol to 4 molecules of toluene diisocyanate, the adduct of 3 moles of m-α,α,α′,α′-tetramethyl xylene diisocyanate to 1 mole of trimethylol propane, the isocyanurate trimer of 1,6-diisocyanatohexane, the isocyanurate trimer of isophorone diisocyanate, the uretdion dimer of 1,6-diisocyanatohexane, the biuret of 1,6-diisocyanatohexane, the allophanate of 1,6-diisocyanatohexane, and mixtures thereof. Furthermore, (co)polymers of isocyanate-functional monomers such as α,α′-dimethyl-m-isopropenyl benzyl isocyanate are suitable for use.

The polyisocyanate can comprise hydrophilic groups, for example covalently bonded hydrophilic polyether moieties, which facilitate the formation of aqueous dispersions.

It is preferred that use be made of an aliphatic or cycloaliphatic di- or triisocyanate containing 8-36 carbon atoms.

Suitable polyalcohols b1 which can be used in the preparation of the polyurethane include diols and triols and mixtures thereof, but higher-functionality polyols can also be used. Examples of such lower-molecular weight polyols include ethylene glycol, diethylene glycol, tetraethylene glycol, propane-1,2- and 1,3-diol, butane-1,4- and -1,3-diol, hexane-1,6-diol, octane-1,8-diol, neopentyl glycol, 1,4-bis-hydroxymethyl cyclohexane, 2-methyl-propane-3-diol, 2,2,4-trimethylpentane-1,3-diol, dipropylene glycol, polypropylene glycols, dibutylene glycol, polybutylene glycols, bisphenol A and tetrabromo bisphenol A, glycerol, pentaerythritol, trimethylol propane, ditrimethylol propane, hexane-1,2,6-triol, butane-1,2,4-triol, quinitol, mannitol, sorbitol, methyl glycoside, 1,4,3,6-dianhydrohexitols, the monoester of neopentylglycol and hydroxy pivalic acid, bis(hydroxyethyl) terephthalate, furan dimethanol, and the reaction products up to molecular weight 400 of such polyols with propylene oxide and/or ethylene oxide.

The organic polymeric polyols b2 which can be used in the preparation of the polyurethane include diols and triols and mixtures thereof, but also higher-functionality polyols can be used, for example as minor components in admixture with diols. The polymeric polyols suitably are selected from the group of polyesters, polyester amides, polyethers, polythioethers, polycarbonates, polyacetals, polyolefins, and polysiloxanes.

Polyester polyols which can be used include hydroxyl-terminated reaction products of polyhydric alcohols, such as ethylene glycol, propylene glycol, diethylene glycol, neopentyl glycol, 1,4-butane diol, 1,6-hexane diol, furan dimethanol, dimethylol cyclohexane, glycerol, trimethylol propane, pentaerythritol, and mixtures thereof with polycarboxylic acids, especially dicarboxylic acids or their ester-forming derivatives, for example succinic, glutaric, and adipic acids, and their dimethyl esters, phthalic anhydride, hexahydrophthalic anhydride, dimethyl terephthalate, and mixtures thereof. Polyesters obtained by the polymerization of lactones, for example caprolactone, in conjunction with a polyol, can also be used.

Polyester amides can be obtained by the inclusion of aminoalcohols such as ethanolamine in the polyesterification mixtures.

Suitable polyether polyols include polyalkylene oxide glycol, wherein the alkylene oxide may be selected from ethylene oxide and/or propylene oxide units.

Polythioether polyols which can be used include products obtained by condensing thiodiglycol either alone or with other glycols, dicarboxylic acids, formaldehyde aminoalcohols or aminocarboxylic acids.

Polycarbonate polyols include products obtained by reacting diols, such as 1,3-propane diol, 1,4-butane diol, 1,6-hexane diol, 1,4-cyclohexane dimethanol, diethylene glycol or tetraethylene glycol, with diaryl carbonates, for example diphenyl carbonate, or with phosgene. Polyurethane resins that comprise carbonate groups are described in more detail in WO 01/48106, and are included herein by reference.

Suitable polyolefin polyols include hydroxy-terminated butadiene homo- and copolymers.

Compounds having one isocyanate-reactive group e) may optionally be used in the preparation of the polyurethane as a chainstopper to limit the molecular weight of the polyurethane. Suitable compounds are well known in the art and include monoalcohols, monoamines, and monothiols.

The polyurethane resins can contain organic solvents for reduction of the viscosity. Suitable solvents are aromatic hydrocarbons such as toluene and xylene; alcohols such as ethanol, isopropanol, n-butanol, 2-butanol, hexanol, benzyl alcohol, and ketones such as methylethyl ketone, methylisobutyl ketone, methylamyl ketone, and ethylamyl ketone; esters such as butyl acetate, butyl propionate, ethoxyethyl propionate, ethylglycol acetate, butylglycol acetate, and methoxypropyl acetate; ethers such as 2-methoxypropanol, 2-methoxybutanol, ethylene glycol monobutyl ether, propylene glycol monopropyl ether, propylene glycol monobutyl ether, dioxolane or mixtures thereof. Examples of other suitable solvents are N-methyl-2-pyrrolidone, dimethyl carbonate, propylene carbonate, butyrolactone, and caprolactone.

In a special embodiment, the polyurethane resin is present in the form of an aqueous dispersion or solution. It is then appropriate to facilitate the dispersion or dissolution of the organic polyurethane resin in water with the aid of external emulsifiers as mentioned above or by ionic and/or non-ionic stabilizing groups built into the polyurethane.

Suitable ionic stabilizing groups can be derived from carboxylic acid groups, sulphonic acid groups, phosphorous acid groups, phosphoric acid groups, and phosphonic acid groups.

Carboxylic acid groups can be introduced into the polyurethanes by the co-reaction of hydroxycarboxylic acids. Dimethylol propionic acid, hydroxypivalic acid, and hydroxystearic acid are preferred.

Sulphonate groups or sulphonic acid groups can be introduced into a polyurethane, for example by reaction of isocyanates and hydroxyl- or amine-functional compounds comprising at least one sulphonic acid group or sulphonate group, for example 2-hydroxethane sulphonic acid, the sodium salt of 2-aminoethane sulphonic acid, 3-cyclohexylamino-1-propane sulphonic acid, the reaction product of an aminoalkylsulphonic acid or its salt with an epoxide-functional compound, the reaction product of sodium 5-sulphoisophthalic acid with an equivalent excess of diols, triols or epoxy compounds. Hydroxyl-terminated oligoesters of sodium 5-sulphoisophthalic acid are particlularly suitable. Such oligoesters may contain reacted units of polycarboxylic acids such as adipic acid, phthalic acid, isophthalic acid, hexahydrophthalic anhydride, trimellitic anhydride, etc.

It is preferred that more than 50% of the sulphonic acid groups and carboxylic acid groups of the polyurethane binder are neutralized with a base. Advantageously, the neutralizing agent is ammonia and/or an amine. Tertiary amines are preferred. Examples of suitable tertiary amines include trimethyl amine, triethyl amine, triisopropyl amine, tributyl amine, triethanol amine, triisopropanol amine, N,N-dimethyl ethanol amine, N,N-dimethyl isopropyl amine, N,N-diethyl ethanol amine, 1-dimethylamino-2-propanol, 3-dimethyl amino-1-propanol, 2-dimethylamino-2-methyl-1-propanol, N-methyl diethanol amine, N-ethyl diethanol amine, N-butyl diethanol amine, N,N-dimethyl cyclohexylamine, N,N′-dimethylpiperazine, N-methyl piperidine, N-methyl morpholine, and N-ethyl morpholine. Suitable primary amines are for example isopropyl amine, butyl amine, ethanolamine, 3-amino-1-propanol, 1-amino-2-propanol, 2-amino-2-methyl-1-propanol or 2-amino-2-methyl-1,3-propane diol. Secondary amines that can be used are for example morpholine, diethyl amine, dibutyl amine, N-methyl ethanolamine, diethanol amine, or diisopropanol amine. Also mixtures of these amines may optionally be used.

Alternatively, alkali metal hydroxides such as sodium hydroxide or potassium hydroxide can be used as neutralizing agents. Neutralization can be carried out prior to, during or after polyurethane formation.

The polyurethane resin present as an aqueous dispersion can also comprise non-ionic stabilizing groups. Non-ionic stabilizing groups can comprise C₁-C₄ alkoxy polyalkylene oxide groups. The preferred alkylene oxide groups are ethylene oxide groups, but propylene oxide groups or mixtures of ethylene oxide groups and propylene oxide groups are useful as well. For example, the alkylene oxide groups may be C₁-C₄ alkoxy ethers of polyalkylene glycols represented by the formula I:

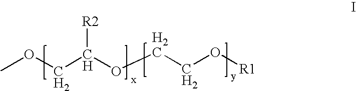

wherein R1 is a hydrocarbon radical with 1 to 4, preferably 1 or 2, carbon atoms; R2 is a methyl group; x is between 0 and 40, preferably between 0 and 20, most preferably between 0 and 10; y is between 0 and 50, and x+y is between 2 and 50, preferably between 2 and 25. Examples are C₁-C₄ alkoxy polyC₂(C₃)alkylene oxide glycol and/or C₁-C₄ alkoxy. polyC₂(C₃)alkylene oxide 1,3-diol, wherein polyC₂(C₃)alkylene oxide stands for polyethylene oxide, optionally comprising propylene oxide units. Suitably, the polyurethane comprises 2.5 to 15 wt. % C₁-C₄ alkoxy polyalkylene oxide groups with a number average molecular weight of 500 to 3,000.

Suitable compounds comprising C₁-C₄ alkoxy polyalkylene oxide groups contain at least one isocyanate reactive group. Examples are methoxy polyC₂(C₃)-alkylene oxide glycols and methoxy polyC₂(C₃)alkylene oxide-1,3-diols, such as Tegomer® D-3123 (PO/EO=15/85; Mn=1,180), Tegomer® D-3409 (PO/EO=0/100; Mn=2,240), and Tegomer® D-3403 (PO/EO=0/100; Mn=1,180) available from Goldschmidt AG, Germany, and MPEG 750 and MPEG 1000. Polyester polyols comprising polyalkylene oxide groups can be used as well.

The introduction of the compounds comprising C₁-C₄ alkoxy polyalkylene oxide groups and at least one isocyanate-reactive group into the polyurethane can be conducted in the course of the polyurethane preparation.

A further suitable class of non-ionic stabilizing groups for water borne polyurethane resins is formed by polyoxazolines.

Mixing the polyurethane resin with an aqueous medium can be done conveniently by adding water to the polyurethane solution or, alternatively, by adding the polyurethane solution to water, under agitation of the water and the polyurethane solution. The organic solvent content of the resulting emulsion or dispersion can be reduced by distillation, optionally under reduced pressure.

Polyester Resins of Coating Composition a)

As suitable polyester resins may be mentioned the condensation products of a carboxylic acid or a reactive derivative thereof, such as the corresponding anhydride or lower alkyl ester with an alcohol. Examples of suitable polycarboxylic acids or reactive derivatives thereof are tetrahydrophthalic acid, tetrahydrophthalic anhydride, hexahydrophthalic acid, hexahydrophthalic anhydride, methyl hexahydrophthalic acid, methyl hexahydrophthalic anhydride, dimethyl cyclohexane dicarboxylate, 1,4-cyclohexane dicarboxylic acid, 1,3-cyclohexane dicarboxylic acid, phthalic acid, phthalic anhydride, isophthalic acid, terephthalic acid, 5-tert. butyl isophthalic acid, trimellitic anhydride, maleic acid, maleic anhydride, fumaric acid, succinic acid, succinic anhydride, hydroxy succinic acid, dodecenyl succinic anhydride, dimethyl succinate, glutaric acid, adipic acid, dimethyl adipate, azelaic acid, and mixtures thereof. Examples of suitable monocarboxylic acids include hexanoic acid, heptanoic acid, octanoic acid, nonanoic acid, 2-ethyl hexanoic acid, isononanoic acid, decanoic acid, lauric acid, myristic acid, palmitic acid, isostearic acid, stearic acid, hydroxystearic acid, benzoic acid, tert.-butyl benzoic acid, lactic acid, dimethylol propionic acid, and mixtures thereof. Suitable alcohols are the same as described above for polyurethane preparation under b1 and b2.

In a special embodiment, the polyester resin is present as an aqueous solution or dispersion. Suitable measures to facilitate the dispersion or dissolution of the organic polyester resin in water with the aid of an external emulsifier or by ionic and/or non-ionic stabilizing groups built into the polyester have already been described above for polyurethanes.

Polyether Resins and Hybrid Resins of Coating Composition a)

As suitable polyether resins may be mentioned the polymers of cyclic ethers such as ethylene oxide, propylene oxide, other epoxides, oxetane, and tetrahydrofuran.

Suitable hybrid resins are described in WO 01/90265, which is included in this application by reference.

The Thiol Groups in Coating Composition a)

Coating composition a) comprises an effective number of thiol groups. This may be accomplished by a composition a) comprising at least a resin such as described above and a compound comprising said thiol groups. Alternatively, thiol groups are covalently attached to the resin present in coating composition a). In another embodiment of the invention coating composition a) comprises both thiol groups covalently attached to a resin and a thiol-functional compound selected from the compounds and resins described below.

Coating composition a) generally has a thiol number of 0.5-600, preferably of 5-200, more preferably of 10-100 mg KOH/g.

Thiol-Functional Compounds

Compounds with an effective number of thiol groups that can suitably be used in coating composition a) include dodecyl mercaptan, mercapto ethanol, 1,3-propanedithiol, 1,6-hexanedithiol, methylthioglycolate, 2-mercaptoacetic acid, mercapto succinic acid, and cysteine.

Esters of Thiol-Functional Carboxylic Acids

Also suitable are esters of a thiol-functional carboxylic acid with a polyol, such as esters of 2-mercaptoacetic acid, 3-mercaptopropionic acid, 2-mercapto-propionic acid, 11-mercaptoundecanoic acid, and mercapto succinic acid. Examples of such esters include pentaerythritol tetrakis (3-mercapto-propionate), pentaerythritol tetrakis (2-mercaptoacetate), trimethylol propane tris (3-mercaptopropionate), trimethylol propane tris (2-mercaptopropionate), and trimethylol propane tris (2-mercaptoacetate). A further example of such a compound consists of a hyperbranched polyol core based on a starter polyol, e.g. trimethylol propane and dimethylol propionic acid, which is subsequently esterified with 3-mercaptopropionic acid and isononanoic acid. These compounds are described in European patent application EP-A-0 448 224 and international patent application WO 93/17060.

Addition Products of H₂S to Epoxy-Functional Compounds

Addition products of H₂S to epoxy-functional compounds also give thiol-functional compounds. These compounds may have a structure of the following formula T[(O—CHR—CH₂—O)nCH₂CHXHCH₂YH]ₘ, with T being a m valent organic moiety, R being hydrogen or methyl, n being an integer between 0 and 10, X and Y being oxygen or sulphur, with the proviso that X and Y are not equal. An example of such a compound is commercially available from Cognis under the trademark Capcure® 3/800.

Other Routes Towards Thiol-Functional Compounds

Other syntheses to prepare compounds comprising thiol-functional groups involve: the reaction of an aryl or alkyl halide with NaHS to introduce a pendant mercapto group into the alkyl and aryl compounds, respectively; the reaction of a Grignard reagent with sulfur to introduce a pendant mercapto group into the structure; the reaction of a polymercaptan with a polyolefin according to a nucleophilic reaction, an electrophilic reaction or a radical reaction; the reaction of disulfides; and other routes such as mentioned in Jerry March, Advanced Organic Chemistry, 4^{th} edition, 1992, page 1298.

Preferred thiol-functional compounds are pentaerythritol tetrakis(3-mercapto propionate), trimethylolpropane tris(3-mercaptopropionate), and Capcure 3/800.

Thiol Groups Covalently Attached to the Resins of Coating Composition a)

In another embodiment of the invention the thiol groups in composition a) can be covalently attached to said at least one resin. Such resins include thiol-functional polyurethane resins, thiol-functional polyester resins, thiol-functional polyaddition polymer resins, thiol-functional polyether resins, thiol-functional polyamide resins, thiol-functional polyurea resins, and mixtures thereof. Thiol-functional resins can be prepared by the reaction of H₂S with an epoxy group or an unsaturated carbon-carbon bond-containing resin, the reaction between a hydroxyl-functional resin and a thiol-functional acid, and by the reaction of an isocyanate-functional polymer and either a thiol-functional alcohol or a di- or polymercapto compound.

Thiol-Functional Resins with a Polyurethane Backbone

A thiol-functional polyurethane resin can be the reaction product of a di-, tri- or tetrafunctional thiol compound with an isocyanate-terminated polyurethane and preferably is the reaction product of a diisocyanate compound and (a) diol-functional compound(s). Suitable thiol-functional polyurethane resins are obtainable by first preparing an isocyanate-functional polyurethane from diols, diisocyanates, and optionally building blocks containing groups which facilitate the stabilization of the resin in an aqueous dispersion, followed by reaction of the isocyanate-functional polyurethane with a polyfunctional thiol in a base-catalyzed addition reaction. Other, thiol-functional polyurethane resins are known and described, e.g., in German patent publication DE-A-26 42 071 and European patent application EP-A-0 794 204.

Thiol-Functional Resins with a Polyester Backbone

The thiol-functional resin can be a polyester prepared from (a) at least one polycarboxylic acid or reactive derivatives thereof, (b) at least, one polyol, and (c) at least one thiol-functional carboxylic acid. The polyesters preferably possess a branched structure. Branched polyesters are conventionally obtained through condensation of polycarboxylic acids or reactive derivatives thereof, such as the corresponding anhydrides or lower alkyl esters, with polyalcohols, when at least one of the reactants has a functionality of at least 3.

Examples of suitable polycarboxylic acids or reactive derivatives thereof and of suitable polyols have been described above for polyester preparation and polyurethane preparation under b1 and b2, respectively.

Examples of suitable thiol-functional carboxylic acids have also been mentioned above. Optionally, monocarboxylic acids and monoalcohols may be used in the preparation of the polyesters. Preferably, C₄-C₁₈ monocarboxylic acids and C₆-C₁₈ monoalcohols are used. Examples of the C₄-C₁₈ monocarboxylic acids have been describe above. Examples of the C₆-C₁₈ monoalcohols include cyclo-hexanol, 2-ethylhexanol, stearyl alcohol, and 4-tert. butyl cyclohexanol.

Thiol-Functional Resins with a Polyaddition Polymer Backbone

The thiol-functional resin can be a thiol-functional polyaddition polymer, for example a poly(meth)acrylate. Such a poly(meth)acrylate is derived from hydroxyl-functional (meth)acrylic monomers, such as hydroxy ethyl (meth)acrylate, hydroxy propyl (meth)acrylate, hydroxy butyl (meth)acrylate, and other ethylenically unsaturated polymerizable monomers as described above for the polyaddition polymer preparation. The thiol group is introduced by esterification of (part of the hydroxyl groups of the acrylate copolymer with one or more of the thiol-functional carboxylic acids described above.

Alternatively, glycidyl methacrylate is:introduced into the polymer to prepare an epoxy-functional poly(meth)acrylate. The epoxy groups are then reacted with suitable thiol-functional carboxylic acids such as mentioned above. Alternatively, the thiol group can be introduced by reacting an isocyanate-functional polyacrylate with a thiol-functional alcohol, e.g., mercapto ethanol. The polyaddition polymer is prepared by conventional methods as described above, for instance by the slow addition of appropriate monomers to a solution of an appropriate polymerization initiator, such as an azo or peroxy initiator.

The Optional Second Resin in Coating Composition a)

Coating composition a) may optionally comprise at least a second resin. Such a second resin is not identical to the resin already present in composition a) and can be selected from the same group of polyaddition polymer, polyester, polyurethane, polyether resins or a mixture thereof. Suitable polyaddition polymer, polyurethane, polyester, and polyether resins can be selected from the groups as described above.

Preferred Embodiments of Coating Composition a)

Coating composition a) may be solvent borne or water borne. Coating composition a) optionally comprises a curing agent capable of chemical reaction with the functional groups present in coating composition a). Examples of such functional groups are hydroxyl groups and thiol groups. In this case coating composition a) is at least partly curable by chemical reaction. When the curing agent comprises thiol-reactive groups, it should be ensured that the thiol groups in layer a) are not fully depleted before the application of layer b). This can suitably be achieved with a coating composition a) which comprises a curing agent comprising thiol-reactive groups, in particular isocyanate groups, and wherein the molar ratio of these thiol-reactive groups and thiol groups in coating composition a) is below 0.5. In a preferred embodiment coating composition a) is a physically drying coating composition. In an especially preferred embodiment coating composition a) comprises a thiol-functional polyurethane resin, preferably as disclosed in WO 99/67339, and a polyacrylate dispersion, preferably as disclosed in EP-A-0 287 144. In another especially preferred embodiment coating composition a) comprises a polyacrylate dispersion and a polyurethane resin, such as described in WO 01/48106, and a thiol-functional compound. These coating compositions may be water borne.

In a further especially preferred embodiment coating composition a) comprises a polyacrylate resin, a polyester resin, and a cellulose compound, as described in more detail in WO 02/36699, as well as a thiol-functional compound. This coating composition may be solvent borne.

Coating Composition b)

Coating composition b) comprises at least one resin that is normally used in coatings such as polyaddition polymer, polyurethane, polyester, polyether or polycarbonate resins and hybrids and mixtures of such resins, and an effective number of thiol-reactive groups. The thiol-reactive groups can be introduced by thiol-reactive groups-comprising compounds. Alternatively, thiol-reactive groups are covalently attached to the resin present-in coating composition b).

In another embodiment composition b) comprises at least a second resin. Such a second resin is not identical to the resin already present in composition b) and can be selected from the group of polyaddition polymer, polyester, polyurethane, polyether, and polycarbonate resins or mixtures thereof, such as described in more detail above.

In another embodiment of the invention coating composition b) comprises, both a thiol-reactive group-containing resin and a thiol-reactive group-containing compound selected from the compounds and resins described below.

In still another embodiment composition b) is a 2-component composition and comprises a component (i) which comprises thiol-reactive groups and a second component (ii) comprising groups which are reactive with thiol-reactive groups. Such a coating composition b) is curable by chemical reaction.

It is to be understood that the above-mentioned one resin which is at least present in coating composition b) may optionally be functionalized with the thiol-reactive groups of component (i) or with the reactive groups of component (ii), or it may additionally be present in the 2-component composition.

Thiol-Reactive Groups in Coating Composition b)

The thiol-reactive groups can be selected from the group of isocyanate groups, epoxy groups, Michael acceptor groups, electron rich carbon-carbon double bond-containing groups, acetal groups, carboxyl groups, ester groups, amide groups, cyclocarbonate groups, alkoxy silane groups, etherified amino groups, lactone groups, lactam groups, (cyclic) ketone groups, aldehyde groups, (cyclic) ketene acetal groups, carbodiimide groups, and thiol groups.

Isocyanates as Thiol-Reactive Groups in Coating Composition b)

In one embodiment at least a resin and a compound which contains isocyanate groups are present in coating composition b). Where the term “isocyanate” is used, blocked isocyanates are included in such term. Blocked isocyanates are described in Prog. Org. Coat, 36 (1999), pp. 148-172.

Suitable compounds with an effective number of isocyanate groups suitable for use as thiol-reactive compound in composition b) include any isocyanate known from polyurethane chemistry such as described above under suitable polyisocyanates in the preparation of a polyurethane. Preferred isocyanates are the isocyanurate trimer of 1,6-diisocyanatohexane, the isocyanurate trimer of isophorone diisocyanate, the uretdion dimer of 1,6-diisocyanatohexane, the biuret of 1,6-diisocyanatohexane, the allophanate of 1,6-diisocyanatohexane, and mixtures thereof.

In coating composition b) the isocyanate groups can also be covalently attached to said at least one resin.

In still another embodiment of composition b) where composition b) is a 2-component composition, a resin or compound comprising isocyanate-reactive groups is present. Such isocyanate-reactive groups comprise for example hydroxyl groups, amine groups, carboxylic acid groups, and thiol groups. Suitable resins comprising isocyanate-reactive groups include hydroxyl-functional polyaddition polymers, e.g. poly(meth)acrylate resins, hydroxyl-functional polyesters, and hydroxyl-functional polyurethanes, for example such as described in U.S. Pat. No. 5,155,201 and U.S. Pat. No. 6,096,835. Other suitable compounds having isocyanate reactive groups are latent hydroxyl compounds, for example bicyclic orthoester-functional compounds, such as described in WO 97/31073.

Epoxide Groups as Thiol-Reactive Groups in Coating Composition b)

Compounds with an effective number of epoxide groups suitable for use as a thiol-reactive compound in coating composition b) include any epoxide known from coatings chemistry, such as glycidyl ethers, glycidyl esters, and epoxidized unsaturated carbon-carbon bond-containing compounds. Examples include diglycidyl or polyglycidyl ethers of (cyclo)aliphatic or aromatic hydroxyl compounds, such as ethylene glycol, glycerol, cyclohexane diol, and mononuclear or polynuclear difunctional or trifunctional phenols and bisphenols such as bisphenol A and bisphenol F; epoxidized oils and epoxidized aliphatic and/or cycloaliphatic alkenes, such as dipentene dioxide, dicyclopentadiene dioxide, and vinyl cyclohexene dioxide.

In coating composition b) the epoxide groups can also be covalently attached to said at least one resin.

In yet another embodiment of coating composition b) where coating composition b) is a 2-component composition, a resin or compound comprising epoxide-reactive groups is present. Such epoxide-reactive groups comprise for example thiol groups, phosphonic acid groups, carboxylic acid groups or amine groups. Suitable resins comprising epoxide-reactive groups include amine-functional resins, thiol-functional resins, carboxylic acid-functional resins, and phosphonic acid-functional resins.

Said amine groups may also be of the polyoxyalkyleneamine type, commercially available as Jeffamines. Further examples are a polyamine obtainable by reaction of a polyepoxide with an amino compound having at least two active hydrogen atoms at a ratio of at most 0.5 equivalent of active hydrogen atoms per epoxide equivalent, followed by conversion of the residual epoxide groups with ammonia, and a blocked amine resin such as a polyketimine or polyaldimine.

Michael Acceptor Groups as Thiol-Reactive Groups in Coating Composition b)

Compounds with an effective number of Michael acceptor groups suitable for use as a thiol-reactive compound in composition b) include any compound containing two or more olefinically unsaturated groups, with the olefinically unsaturated groups comprising at least one electron-withdrawing functionality linked to a carbon atom of the unsaturated bond, as described in WO 00/64959 incorporated herein by reference.

In composition b) the Michael acceptor groups can also be covalently attached to said at least one resin. Suitable resins of this type: include (meth)acryloyl-functional polyaddition polymers, polyurethanes, and polyesters. Examples of such resins are described in U.S. Pat. No. 4,990,577 and references cited therein.

In another embodiment of composition b) where composition b) is a 2-component composition, a resin or compound comprising Michael donor groups is present. Such Michael donor groups comprise for example 2,4-pentadione groups, acetoacetate groups, malonate groups, thiol groups, and amine groups. Suitable resins comprising Michael donor groups are described in more detail in EP-A-0 161 697 and U.S. Pat. No. 4,772,680.

In a particular embodiment of the invention the Michael acceptor groups as defined above can also be cured by actinic radiation, such as described in WO 02/34808.

Electron Rich Carbon-Carbon Double Bond Groups as Thiol-Reactive Groups in Coating Composition b)

Compounds with an effective number of electron rich carbon-carbon double bond-containing groups suitable for use as a thiol-reactive compound in composition b) include any compounds containing carbon-carbon double bonds substituted with ether, ester, and alkyl groups, as described in J. March, Advanced Organic Chemistry, 4^{th} edition, page 14, table 1.3. Examples of groups having these types of carbon-carbon double bonds are: allyl, allyl ether, vinyl ether, vinyl ester, and unsaturated fatty acids groups.

In composition b) the electron rich carbon-carbon double bond-containing groups can also be covalently attached to said at least one resin. Suitable resins of this type include polyesters having allyl ether groups, unsaturated fatty acid-functional groups or vinyl ether groups. Examples of such resins are described in WO 99/47617. The reaction between thiol groups and electron rich carbon-carbon double bonds can be initiated by free radical forming compounds, such as photo-initiators, peroxides, etc. Oxidative curing of electron rich carbon-carbon double bond-containing groups can accompany or initiate the addition of thiol groups to these types of carbon-carbon double bonds.

In another embodiment of composition b) where composition b) is a 2-component composition, a resin or compound comprising electron rich carbon-carbon double bond-reactive groups is present. Such electron rich carbon-carbon double bond-reactive groups comprise for example electron poor carbon-carbon double bonds, which can undergo curing: by a charge-transfer polymerization mechanism, such as described in U.S. Pat. No. 5,446,073 and U.S. Pat. No. 6,271,339. If the electron rich carbon-carbon double bonds are suitable dienes, they can also be cured by a Diels-Alder addition reaction, such as described in EP-A-0 357 110.

In a particular embodiment of the invention the electron rich carbon-carbon double bond-containing groups as defined above can also be cured by a cationic polymerization reaction.

Acetal Groups as Thiol-Reactive Groups in Coating Composition b)

Compounds with an effective number of acetal groups suitable for use as thiol-reactive compound in composition b) are suitably based on aminoacetals represented by formula II below

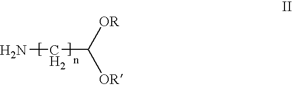

wherein n is an integer from 1 to 10 and R and R′ may be the same or different and represent alkyl groups with 1 to 4 carbon atoms. Such compounds and resins are known in the art. In United States patent publication U.S. Pat. No. 4,663,410 the preparation and use of polymerizable amide acetals from aminoacetals is described. Also the direct reaction of an aminoacetal with either a polymerizable monoisocyanate such as m-isopropenyl-dimethylbenzyl isocyanate or with a polyisocyanate, such as described in European patent publication EP-A 1 050 550, is a suitable route towards acetal-functional compounds and resins. Acetal-functional compounds and resins obtainable by amidation of esters with aminoacetals of formula 11 can also be used in the coating system of the invention. The preparation of suitable acetal-functional binders of this kind is for example described in U.S. Pat. No. 5,360,876

In yet another embodiment of composition b) where composition b) is a 2-component composition, a resin or compound comprising acetal-reactive groups is present. Such acetal-reactive groups comprise for example thiol groups, hydroxyl groups, carbamate groups, and acetal groups.

Carboxyl Groups, Ester Groups, and Amide Groups as Thiol-Reactive Groups in Coating Composition b)

Compounds with an effective number of carboxyl groups, ester groups, and amide groups suitable for use as a thiol-reactive compound in composition b) are readily commercially available. Generally, most of the resins and compounds described above comprise an effective number of such groups.

Alkoxy Silane Groups as Thiol-Reactive Groups in Coating Composition b)

Compounds and resins with an effective number of alkoxy silane groups suitable for use as a thiol-reactive compound in composition b), as well as alkoxy silane-reactive groups, are well known in the art. Examples are described in WO 98/23691.

Etherified Amino Groups as Thiol-Reactive Groups in Coating Composition b)

Examples of suitable compounds comprising etherified amino groups are urea resins, guanamine resins, and melamine resins, and mixtures of these. Examples of urea resins are etherified methylol urea, butyl urea, and isobutyl urea. One example of a guanamine resin is tetra(methoxymethyl)benzo-guanamine. Examples of melamine resins are hexa(methoxymethyl)melamine (HMMM) and isobutylated melamine.

In yet another embodiment of composition b) a resin comprising etherified amino group-reactive groups is additionally present. Such groups comprise for example thiol groups and in particular hydroxyl groups.

Aldehyde Groups as Thiol-Reactive Groups in Coating Composition b)

Compounds and resins with an effective number of aldehyde groups suitable for use as a thiol-reactive compound in composition b), as well as aldehyde-reactive groups, are well known in the art. Examples are described in WO 02/14399.

Cyclocarbonate Groups as Thiol-Reactive Groups in Coating Composition b)

Compounds and resins with an effective number of cyclocarbonate groups suitable for use as a thiol-reactive compound in composition b) can conveniently be prepared from epoxide-functional precursors, as mentioned above. The reaction of epoxides with carbon dioxide leads to cyclic carbonates and is well known in the art.

In yet another embodiment of composition b) where composition b) is a 2-component composition, a resin or compound comprising cyclocarbonate-reactive groups is present. Suitable cyclocarbonate-reactive groups include the same groups already described as epoxide-reactive groups.

Carbodiimide Groups as Thiol-Reactive Groups in Coating Composition b)

Compounds with an effective number of carbodiimide groups suitable for use as a thiol-reactive compound in composition b) can suitaby be prepared as described in Organic Syntheses, Coll. Vol. 6, p. 951. Suitable compounds and resins comprising carbodiimide groups are also commercially available, for example XL-29SE from Dow Chemical Company.

In yet another embodiment of composition b) a resin or compound comprising carbodiimide-reactive groups is present. Examples of such carbodiimide-reactive groups are carboxylic acid and carboxylate groups.

Thiol Groups as Thiol-Reactive Groups in Coating Composition b)

Compounds with an effective number of thiol groups suitable for use as a thiol-reactive compound in composition b) include any thiols as mentioned above as components of composition a). The thiol groups can also be covalently attached to said at least one resin. Suitable resins of this type are described above. In yet another embodiment of composition b) a resin or compound comprising thiol-reactive groups is present. Such thiol-reactive groups comprise for example isocyanate groups, epoxy groups, Michael acceptor groups, electron rich carbon-carbon double bonds such as present in polyunsaturated compounds, vinyl ethers, acetal groups, and thiol groups.

Preferred Embodiments

Coating composition b) may be solvent borne or water borne. In a preferred embodiment coating composition b) is solvent borne and comprises an isocyanate-functional compound (cross-linker) and an, optionally latent, hydroxyl-functional resin, preferably as disclosed in WO 98/16583 or WO 97/31073.

In a further embodiment coating composition a) comprises a thiol-functional polyurethane resin and a polyacrylate dispersion, preferably as disclosed in. EP-A-0 287 144 or WO 99/67339, and composition b) comprises an isocyanate-functional compound and an, optionally latent, hydroxyl-functional resin, preferably as disclosed in WO 98/16583 or WO 97/31073.

Catalysts in the Coating Compositions of the Multilayer Coating System

In a preferred embodiment composition a) and/or composition b) of the coating system in addition comprises at least one catalyst for the reaction between thiol-reactive groups and thiol groups. If one of the coating compositions of the coating system of the present invention is curable by chemical reaction, it is suitable that a catalyst for said curing reaction is also present. Suitable catalysts for curing coatings by chemical reaction are known in the art. The catalyst for the chemical curing reaction may be the same as or different from the catalyst for the reaction between thiol-reactive groups and thiol groups. Generally, good results are obtained with bases, salts, water, metal complexes, metal salts, and acids as catalysts.

In a preferred embodiment the catalyst of the reaction between thiol groups and thiol-reactive groups is a basic neutralizing agent. In this embodiment the neutralizing agent of one or more of the coating compositions of the coating system is chosen from the group of compounds that are known to catalyze the reaction between thiol groups and thiol-reactive groups. Examples of suitable neutralizing agents have been mentioned above.

In yet another embodiment the catalyst may be a latent catalyst, such as a photo-activatable catalyst. Such latent catalysts include photolatent bases the conjugated acid of which has a pKa of at most 8, such as N-substituted 4-(o-nitrophenyl) dihydropyridines and quaternary organo-boron photoinitiators. An example of an N-substituted 4-(o-nitrophenyl). dihydropyridine is N-methylnifedipine (Macromolecules 1998, 31, 4798). Examples of quaternary organo-boron photoinitiators are disclosed in GB-A-2 307 473.

Thus far optimum results have been obtained with a photo-activatable base belonging to the group of α-aminoacetophenones. Examples of α-amino-acetophenones which can be used in the coating compositions according to the present invention are 4-(methylthiobenzoyl)-1-methyl-1-morpholino ethane (Irgacure® 907 ex Ciba Specialty Chemicals) and (4-morpholinobenzoyl)-1-benzyl-1-dimethylamino propane (Irgacure® 369 ex Ciba Specialty Chemicals), disclosed in EP-A-0 898 202.

If a combination of a curing agent comprising thiol-reactive groups, in particular polyisocyanates, and a photo-activatable catalyst is employed in coating composition a), the fast photo-induced curing reaction in layer a) may deplete the thiol groups in layer a), thus impeding the reaction between the thiol groups in coating composition a) and the thiol-reactive groups in coating composition b). This may detract from the desired effect of the current invention, i.e. an increase in overall hardness and interlayer adhesion of the multilayer coating system. Therefore, it is preferred that coating composition a) does not comprise a combination of a curing agent comprising thiol-reactive groups and a photo-activatable catalyst, in particular when the molar ratio of these thiol-reactive groups and thiol groups in coating composition a) is 1 or higher.

When the thiol-reactive groups are isocyanate groups, suitable catalysts include triethyl amine, aldimine or metal complexes or metal salts wherein the metal is selected from the group of aluminium, titanium, zirconium, manganese, and hafnium. Good results are obtained when use is made of a catalyzing amount of complexes of zirconium or hafnium and diketones or alkylacetoacetates. Good results have also been obtained with the aluminium complex K-KAT XC5218 (ex King Industries) and with organic titanates such as titanium diisopropoxide bis-2,4(pentadionate) (Tyzor AA ex DuPont). Further examples of satisfactory catalysts are disclosed in U.S. Pat. No. 5,846,897.

When the thiol-reactive groups are functional groups which require acid catalysis for curing and/or for reaction with thiol groups, it is preferable that the composition additionally comprises an acidic catalyst. Suitable acidic catalysts are well known in the art and as an example sulfonic acids may be mentioned, which optionally may be blocked. Examples of groups requiring acid catalysis are acetal groups and resins having etherified amino groups.

When the thiol-reactive groups are functional groups which react via a free radical mechanism in curing and/or in reaction with thiol groups, it is preferable that the composition additionally comprises a free radical generating catalyst. Suitable free radical generating catalysts are well known in the art, for example peroxides, azo compounds, and metal salts.

Additives in the Coating Compositions of the Multilayer Coating System

In the coating compositions a) and/or b) conventional additives for coatings may be present. Such additives include stabilizers, flow additives, fillers, UV-absorbers, catalyst blocking agents, pigments (colour pigments, metallics and/or pearls), wax, defoamers, surfactants, and wetting agents. Both coating compositions may be water borne or solvent borne. Solvent borne compositions may include any solvent known in the art, i.e. aliphatic and/or aromatic hydrocarbons. Examples include toluene, xylene, butyl acetate, ethyl acetate, acetone, methyl isobutyl ketone, methyl isoamyl ketone, methyl ethyl ketone, ether, ether alcohol, ether ester, hexylglycol, butoxyethanol, 1-methoxy-propanol-2,1-ethoxy-propanol-2,1-propoxy-propanol-2,1-butoxy-propanol-2,1-isobutoxy-propanol-2, dipropylene glycol monomethyl ether; methanol, ethanol, propanol, isopropanol, butanol, pentanol, hexanol, ethylene glycol, diethylene glycol, dimethyl dipropylene glycol, diacetone alcohol, methylether of diacetone alcohol, ethoxy ethyl propionate, or a mixture of any of these. Water borne means that the liquid content of the composition comprises a substantial proportion of water, but can also comprise an organic co-solvent. The co-solvents used in water borne compositions include the same ones as the organic solvents mentioned above.

Preferably, the coating compositions a) and b) comprise less .than 780 g/l of volatile organic solvent based on the total composition, more preferably less than 420 g/l, most preferably less than 250 g/l.

Application of the Coating Compositions of the Multilayer Coating System

The coating compositions a) and b) can be applied one after the other without intermediate drying, so called “wet-on-wet” application, but can also be used with an intermediate drying step. The coating compositions a) and b) can be applied in random order and may be a filler composition, a primer composition, a base coat composition, a clear coat composition and/or a top coat composition.

In a preferred embodiment coating composition a) is first applied on a (coated) substrate and subsequently coating composition b) is applied on top of coating composition a) in order to obtain the multilayer coating system according to the invention.

Application onto a substrate can be via any method known to the skilled person, e.g., via rolling, spraying, brushing, flow coating, dipping, and roller coating. Preferably, at least one of the coating compositions a) and b) as described above is applied by spraying.

The coating compositions of the present invention can be applied to any substrate. The substrate may be, for example, metal, e.g., iron, steel, and aluminium, plastic, wood, glass, synthetic material, paper, leather, or another coating layer.

Curing temperatures are preferably between 0 and 80° C., and more preferably between 20 and 60° C.

A specific application of the coating system is as a base coat/clear coat system that is often used in the coating of automobiles and transportation vehicles. The coating system is especially useful in the refinish industry, in particular the body shop, to refinish and to repair automobiles. The coating system is also applicable in the automotive industry for the finishing of large transportation vehicles, such as trains, buses, trucks, and airplanes

### EXAMPLES

General Methods:

The acid value was determined in accordance with ISO 3682.

The hydroxyl value was determined in accordance with ISO 4629.

The thiol value was determined by reaction with AgNO₃ and by titration with tetrabutylammonium hydroxide. (I. Gyenes, Titration in non-aqueous media, pp. 404, 405).

The molecular weight was determined by Gel Permeation Chromatography (GPC) using polystyrene as a standard.

The glass transition temperature (Tg) was determined by DSC (differential scanning calorimetry)

The dispersions' respective average particle size was determined with the aid of dynamic light scattering, with the dispersions diluted to a solids content of about 0.1 wt. %.

The Knoop hardness was determined in accordance with ISO 6441-2 (1999).

The Persoz hardness was determined in accordance with IS01522.

The layer thickness was measured in accordance with ISO 2808.

The adhesion was determined in accordance with ISO 2409 (1992) by making a cross-hatch pattern in the through-hardened coating on which a standard type adhesion tape is stuck and gently pulled off again. Adhesion is expressed on a scale from 1 to 10, where good adhesion is indicated by 10 and bad adhesion is indicated by 1.

Specification of Terms:

PU=Polyurethane

PAD=Polyacrylate dispersion Setalux 6801 AQ-24 ex Akzo Nobel Resins

DMEA=Dimethyl ethanolamine

Setal 6407=Setal 6407 SQ 026, a polyester resin ex Akzo Nobel Resins

DBTL=Dibutyl tin dilaurate

VP LS 2952=Bayhydrol VP LS 2952, a PU dispersion ex Bayer

Dowanol PPH=Dowanol PPH ex Dow Chemicals

Dowanol PM=Dowanol PM ex Dow Chemicals

Desmodur W=Dicyclohexyl methane4,4′-diisocyanate ex Bayer

Amberlite IRA-67=Ion exchange resin ex Rohm & Haas

Penta(SH)4=Pentaerythritol tetrakis (3-mercaptopropionate).

Tone 301=Polyol ex Union Carbide, a subsidiary of Dow Chemical Company

CAB=Solution with a solids content of 21 wt. % of 20 parts CAB 381-01 and 5 parts CAB 381-20 ex Eastman

3110 filler=Autocryl Filler 3110, a 2-component filler ex Akzo Nobel Car Refinishes BV

Autosurfacer 940HS=Surfacer ex Akzo Nobel Car Refinishes BV

Autoclear Vision=High solids clear coat ex Akzo Nobel Car Refinishes BV, comprising a bicyclic orthoester and a polyisocyanate

Autoclear LV420=Clear coat ex Akzo Nobel Car Refinishes BV, comprising a solvent borne acrylate polyol and a polyisocyanate cross-linker

Autoclear MS 2000=Clear coat ex Akzo Nobel Car Refinishes BV, comprising a solvent borne polyacrylate polyol and a polyisocyanate cross-linker

Thinner 123 fast=Solvent mixture ex Akzo Nobel Car Refinishes BV

Cardura E10=Glycidylester of versatic acid ex Shell Chemicals

Polyester Polyol (PE)

PE is a hydroxy-functional polyester with the following monomer composition: 10 wt % 3,5,5-trimethyl hexanoic acid, 49 wt % hexahydrophthalic anhydride, 22 wt % neopentyl glycol, and 19 wt % trimethylol propane, Mn=17,000 (GPC with polystyrene as standard), hydroxyl value=105 mg KOH/g solid resin, acid value=10 mg KOH/g solid resin, Tg=9° C., and solids content=75 wt % in butyl acetate/xylene.

Polyacrylate Polyol (PAPO)

PAPO is a polyacrylate polyol of the following monomer composition: 14.6 wt % hydroxy propyl methacrylate, 37 wt % methyl methacrylate, 47 wt % butyl methacrylate, and 1.4 wt % methacrylic acid, Mw=15,000, Mn=5,000 (GPC with polystyrene as standard), hydroxy value=57 mg KOH/g solid resin, acid value=10 mg KOH/g solid resin, Tg=40° C., and solids content=51 wt % in butanol/xylene.

Preparation of a Polyesterdiol (1)

A 2-litre 4-neck flask was fitted with a variable speed stirrer, thermocouples in combination with a controller, a distillation column, a condenser, a nitrogen sparge, and a heating mantle. In the flask were placed 507.7 g hexahydrophthalic anhydride, 222.8 g neopentylglycol, 308.3 g cyclohexane dimethanol, and 0.52 g dibutyl tin oxide. The mixture was heated to 220° C. with stirring and under nitrogen flow and was kept at this temperature for 4 hours and water was distilled off. Then xylene was added gradually to the flask until distillation of xylene started at a batch temperature of 220° C. Distillation was continued until the distillate contained no more water. Then a vacuum line was attached to the distillate receiver and distillation was continued at reduced pressure until substantially all xylene was removed from the reaction flask. The polyester was cooled to 80° C. and diluted with 420 g 2-butanone. Then the mixture was allowed to cool to room temperature. A clear, colourless polyester solution was obtained with an acid number of 3.7 mg KOH/g, a hydroxyl number of mg 78.8 KOH/g, GPC data Mn 1,190, Mw 1,960.

Preparation of Hydrophilic Polyesterdiol (2)

A 3-litre 4-neck flask was fitted with a variable speed stirrer, thermocouples in combination with a controller, a distillation column, a condenser, a nitrogen sparge, and a heating mantle. In the flask were placed 332 g hexahydrophthalic anhydride and 1614 g polyethylene glycol monomethyl ether of average molecular weight 750. The mixture was heated to 170° C. for 30 minutes, cooled to 140° C., and 269 g di (trimethylol propane) were added, followed by 132 g xylene and 3.3 g of a 85% aqueous phosphoric acid solution. The mixture was heated to 235° C. and water was azeotropically distilled off until the acid value of the reaction mixture was below 5 mg KOH/g. The mixture was then cooled to 180° C. and xylene was distilled off at reduced pressure. The resulting polyester diol solidified at room temperature and had an acid value of 3.9 mg KOH/g and a hydroxyl value of 59 mg KOH/g.

Preparation of a Sulfosuccinate Diol (3)

To a 5-litre, 4-neck round-bottomed flask fitted with a condenser, a thermocouple, a stirrer, and a nitrogen inlet were added 1,249.5 g of Cardura E10. The temperature was raised to 140° C. and then 290.3 g of maleic acid were added in portions in one hour. Thereafter the reaction mixture was heated with stirring to 150° C. After reaching an acid number lower than 2 mg KOH/g, the reaction temperature was lowered to 95° C. Then 475 g of water, 710 g of Dowanol PM, and 228.0 g of sodium dithionite were added, and stirring was continued for one hour at 60° C. and for another hour at 95° C. Water and Dowanol PM were then distilled off from the reaction mixture at reduced pressure, while the last traces were distilled off azeotropically with 300 g of o-xylene. The reaction mixture was then cooled down to room temperature, 600 g of dry 2-butanone were added, and the precipitate was filtered off from the product.

Preparation of a Thiol-Functional Polyurethane Dispersion (4)

A 3-litre 4-neck flask was fitted with a variable speed stirrer, thermocouples in combination with a controller, a condenser, a nitrogen in- and outlet, and a heating mantle. In the flask were placed 467.1 g of the polyesterdiol (1) solution described above, 168.1 g of the hydrophilic polyester (2) described above, 107.5 g of the sulfosuccinate diol (3) described above, 450 g 2-butanone, and 0.4 g tin (II) octanoate. The reaction mixture was heated to 75° C. and subsequently 203.3 g Desmodur W were added during one hour. During the addition period and during an additional 1.5 hours the reaction mixture was kept between 75 and 85° C. The reaction mixture was then cooled to 35° C. and 244.1 g trimethylolpropane (tris)-3-mercaptopropionate were added. Subsequently 34 g of Amberlite IRA-67, which had been dried in a vacuum oven at 40° C., were added. The reaction mixture was stirred for 2 hours at ambient temperature, after which time complete isocyanate conversion was found by titration of a sample. The ion exchange resin was filtered off.

400 g of the above-described resin solution were further diluted with 160 g. acetone in a flask with a variable speed stirrer, thermocouples in combination with a controller, a condenser, a nitrogen in- and outlet, and a heating mantle. The solution was heated to 45° C.; the stirrer was set to 800 rpm and during 2.5 hours 470 g water were added.

When the addition of water was complete, a distillation head and a vacuum pump were connected to the flask and the pressure was gradually lowered until all 2-butanone and acetone was distilled off.

A white emulsion with the following characteristics was obtained: Solids content 26.8 wt. %, Mn 3,400, Mw 31,300, particle size 61 nm, thiol equivalent weight 2,872 g/equivalent, thiol value 20 mg KOH/g, Tg=10° C.

Preparation of Hydroxyl-Functional Polyurethane Dispersion (5)

A 3-litre 4-neck flask was fitted with a variable speed stirrer, thermocouples in combination with a controller, a condenser, a nitrogen in- and outlet, and a heating mantle. In the flask were placed 286.7 g of the polyesterdiol (1) solution described above, 151.9 g of the hydrophilic polyester (2) described above, 76.4 g of the sulfosuccinate diol (3) described above, 340 g 2-butanone, and 0.4 g tin (II) octanoate. The reaction mixture was heated to 75° C. and subsequently 145.0 g. Desmodur W were added during one hour. During the addition period and during an additional 1.5 hours the reaction mixture was kept between 75 and 85° C. The mixture was then cooled to 35° C. and 130 g of Tone 301 were added and mixed in homogeneously. Subsequently the reaction mixture was heated to 85° C. and kept at this temperature for 3 hours, after which time complete isocyanate conversion was found by titration of a sample.

350 g of the above described resin solution were placed in a flask with a variable speed stirrer, thermocouples in combination with a controller, a condenser, a nitrogen in- and outlet, and a heating mantle. The solution was heated to 55° C.; the stirrer was set to 1,000 rpm and during 2 hours 466 g water were added.

When the addition of water was complete, a distillation head and a vacuum pump were connected to the flask and the pressure was gradually lowered until all 2-butanone was distilled off.

A white emulsion with the following characteristics was obtained: Solids content 31.9 wt. %, Mn 2,900, Mw 15,800, particle size 141 nm, hydroxyl equivalent weight 2,316 g/equivalent, hydroxyl value=25 mg KOH/g, Tg=1° C.

Preparation of Hydroxyl-Functional Polyurethane Dispersion (6)

A 3-litre 4-neck flask was fitted with a variable speed stirrer, thermocouples in combination with a controller, a condenser, a nitrogen in- and outlet, and a heating mantle. In the flask were placed 279.9 g of the polyesterdiol (1) solution described above, 81.2 g of the hydrophilic polyester (2) described above, 68.1 g of the sulfosuccinate diol (3) described above, 50 g 2-butanone, and 127.4 g Desmodur W and 0.2 g tin (II) octanoate. The reaction mixture was heated to 70° C. and subsequently exothermed to 85° C. The mixture was stirred at 80° C. for three hours, and subsequently a solution of 51.5 g trimethylol propane and 0.2 g tin (II) octanoate in 85 g 2-butanone (kept at 70° C.) was added and mixed in homogeneously. The reaction mixture was further heated to 80° C. and kept at this temperature for 3 hours, after which time complete isocyanate conversion was found by titration of a sample.

A flask with variable speed stirrer, thermocouples in combination with a controller, a condenser, a nitrogen in- and outlet, and a heating mantle was charged with 357 g water. The water was heated to 55° C.; the stirrer was set to 1,000 rpm and during 40 minutes 197 g of the resin solution described above were added. After the addition of the resin solution an additional amount of 100 g of water was added.

A distillation head and a vacuum pump were connected to the flask and the pressure was gradually lowered until all 2-butanone was distilled off.

A white emulsion with the following characteristics was obtained: Solids content 28.0 wt. %, Mn 5,700, Mw 21,700, particle size 60 nm, hydroxyl equivalent weight 2,275 g/equivalent, Tg=35° C.

### Example 7 and Comparative Examples 8 and 9

Preparation of Water Borne Base Coat Composition (7) and Comparative Water Borne Base Coat Compositions (8) and (9)

Three water borne base coat compositions were prepared. The base coats were tested as unpigmented base coats. This was done to enable a better comparison between the examined dispersions. Base coat composition (7) comprises thiol-functional polyurethane dispersion (4) and base coat compositions (8) and (9) comprise hydroxyl-functional polyurethane dispersions (5) and (6). To have three compositions with a similar glass transition temperature, polyurethane dispersions (5) and (6) were mixed to acquire a glass transition temperature of about 10° C. according to the formula of Young (Introduction to Polymers, p. 298): 1 Tg_{co}=w_{A}/Tg_{A}+w_{B}/Tg_{B}. In the following Table 1 all amounts are in grams.

TABLE 1
Base coat compositions/Examples 7-9

| | Base coat/ | | |
|---|---|---|---|
| | Example | | |
| | 7 | 8 | 9 |
| PAD | 174.3 | 174.3 | 174.3 |
| thiol-functional PU dispersion 4 | 152.8 | | |
| OH-functional PU dispersion 5 | | 97.1 | 97.1 |
| OH-functional PU dispersion 6 | | 44.8 | 44.8 |
| DMEA (5% in water) | 16.6 | 17.48 | 17.5 |
| Butyl glycol/water 1/1 (weight) | 42.9 | 42.9 | 42.9 |
| Additives mixture of 88.9% Setal 6407, | 17.4 | 17.4 | 17.4 |
| 9.35% surfactant, and 1.75% defoaming | | | |
| additives | | | |
| Water | 24.9 | | |
| DBTL (10% in butylacetate/ | | | 0.4 |
| xylene 1:1 weight) | | | |
| pH after 1 day | 7.9 | 7.8 | 7.8 |

### Example 10A to 10 D and Comparative Examples 11A to 11D and 12A to 12D

Application of Water Borne Base Coats 7 to 9 on Substrate

Autosurfacer 940HS was applied on 12 steel panel substrates. Subsequently four of them were sprayed with base coat composition 7 (Example 10A to 10D), four more with base coat composition 8 (Comparative Example 11A to 11D), and another four with base coat composition 9 (Comparative Example 12A to 12D), all using a De Vilbiss spray gun conventional opening 1.4. The base coat layer thickness was about. 25 to 30 μm. After an intermediate drying step a clear coat composition was applied on all twelve panels, using a De Vilbiss LVLP spray gun opening 1.3. The clear coat composition was Autoclear Vision. The Knoop hardness of each panel was determined at a clear coat layer thickness of about 35 (designated XXX.1 in FIG. 1) and 60 μm (designated XXX.2 in FIG. 1). The results are given in FIG. 1.

[image]

Further, the Persoz hardness was determined after 1 day and after 1 week from application of the clear coat. The values for the Persoz hardness are the average values of the clear coat layer thickness of 35 and 60 μm. The results are given in FIG. 2 and Table 2.

[image]

TABLE 2
Average Persoz hardness

| | 1 day | 1 week |
|---|---|---|
| Example 10 | 63 | 72 |
| Example 11 | 32 | 35 |
| Example 12 | 39 | 45 |

The conclusion to be drawn from these experiments is that the hardness of the systems according to the invention is significantly higher than the s of the comparative examples. It was visually established that the use coat composition 7 led to a significantly reduced amount of popping.

### Example 13 and Comparative Examples 14 and 15

Preparation of Water Borne Metallic Pigmented Base Coat Composition 13 and Comparative Water Borne Metallic Pigmented Base Coat Compositions 14 and 15

Three metallic pigmented base coat composition were prepared. Base coat composition (13). comprises thiol-functional polyurethane dispersion (4) and base coat compositions (14) and (15) comprise hydroxyl-functional 41 polyurethane dispersions (5). The compositions are given in Table 3. All amounts are in grams.

TABLE 3
Base coat compositions/Examples 13-15

| | Base coat/Example | | |
|---|---|---|---|
| | 13 | 14 | 15 |
| PAD | 41.0 | 41.0 | 41.0 |
| Thiol-functional PU dispersion 4 | 38.2 | | |
| OH-functional PU dispersion 5 | | 32.1 | 32.1 |
| DMEA (5% in water) | 3.5 | 4.3 | 4.2 |
| Butyl glycol/water 1/1 (weight) | 10.1 | 10.1 | 10.1 |
| Additives, a mixture of 88.9% Setal 6407, | 4.1 | 4.1 | 4.1 |
| 9.35% surfactant, 1.75% defoaming | | | |
| additives | | | |
| DBTL (10% in butylacetate/ | — | — | 0.1 |
| xylene 1:1 weight) | | | |
| Aluminium pigment particles (37% | 14.3 | 14.3 | 14.3 |
| in butylglycol) | | | |
| pH directly after preparation | 8.0 | 8.1 | 8.0 |
| pH after 1 day | 7.8 | 7.9 | 8.0 |

### Example 16 and Comparative Examples 17 and 18

Application of Water Borne Base Coats 13 to 15 on Substrate

Autosurfacer 940HS was applied on three steel panel substrates. Subsequently, one of them was sprayed with base coat composition (13) (Example 16), another with base coat composition 14 (Comparative Example 17), and the third with base coat composition 15 (Comparative Example 18), all using a De Vilbiss spray gun conventional opening 1.4. The base coat composition was applied as specified in the technical information sheet, two layers were sprayed followed by a drying step. Subsequently, on all three panels a clear coat composition was applied after an intermediate drying step using a De Vilbiss conventional spray gun opening 1.3. This clear coat composition was Autoclear Vision.

In Example 16 it was visually established that the use of base coat composition 13 led to significantly reduced popping (number of foam bubbles) compared to the use of base coat compositions 14 and 15 in Comparative Examples 17 and 18.

### Examples 19 to 21 and Comparative Examples 22 to 24

Preparation of Water Borne Base Coat Compositions 19 to 21 and Comparative Water Borne Base Coat Compositions 22 to 24

Six coloured base coat composition were prepared. Base coat compositions 19 to 21 comprise thiol-functional polyurethane dispersion (4) and comparative base coat compositions 22 to 24 comprise a hydroxyl-functional polyurethane (VP LS 2952). The compositions are given in Table 4. All amounts are in grams.

TABLE 4
Composition of base coats 19 to 21 and comparative base coats 22
to 24

| Base coat | | | | | | |
|---|---|---|---|---|---|---|
| composition/ | | | | | | |
| Example | 19 | 20 | 21 | 22 | 23 | 24 |
| PAD | 17.57 | 26.97 | 19.07 | 17.57 | 26.97 | 19.07 |
| VP LS 2952 | | | | 22.00 | 16.85 | 23.85 |
| Thiol-functional PU | 28.30 | 21.67 | 30.68 | | | |
| dispersion (4) | | | | | | |
| Water | 22.09 | 21.77 | 13.39 | 28.39 | 26.59 | 20.21 |
| DMEA (5% in | 2.69 | 4.12 | 3.31 | 2.69 | 4.12 | 3.31 |
| water) | | | | | | |
| Butylglycol/water | 15.90 | 8.85 | 13.18 | 15.90 | 8.85 | 13.18 |
| 1/1 (weight) | | | | | | |
| Dowanol PPH | 1.20 | 0.77 | 1.00 | 1.20 | 0.77 | 1.00 |
| Paste I* | 12.67 | | | 12.67 | | |
| Paste II** | | 16.47 | | | 16.47 | |
| Paste III*** | | | 18.87 | | | 18.87 |
| Additives**** | 1.57 | 1.45 | 1.72 | 1.57 | 1.45 | 1.72 |
| pH (directly after | 8.14 | 8.40 | 8.51 | 7.46 | 8.15 | 8.13 |
| mixing) | | | | | | |

*Paste I: Water borne pigment concentrate with a solids content of 59.2 wt. %, containing a dispersant and pigment Irgazin DPPRed BO ex Ciba-Geigy.
**Paste II: Water borne pigment concentrate with a solids content of 40.8 wt. %, containing a dispersant and pigment Quindo Violet RV 6926 ex Bayer.
***Paste III: Water borne pigment concentrate with a solids content of 37.9 wt. %, containing a dispersant and pigment Hostaperm-Pink E ex Clariant.
****Additives means a mixture of a surfactant and a fungicide.

### Examples 25 to 27 and Comparative Examples 28 to 30

Application of Water Borne Base Coats 19 to 24 on Substrate

Six degreased tin plate substrates were sprayed with the base coat compositions in an increasing layer thickness (15-26 μm), one plate with base coat composition 19 (Example 25), another with base coat composition 20 (Example 26), a third with base coat composition 21 (Example 27), a fourth with base coat composition 22 (Comparative Example 28), a fifth with base coat composition 23 (Comparative Example 29), and a sixth with base coat composition 24 (Comparative Example 30), all using a Devilbiss 1.4 F conventional spray gun. The base coats were dried under enforced conditions by making use of air-jets. The hardness of the base coats was judged by feeling with a finger. The difference between Examples 25 to 27 and Comparative Examples 28 to 30 was clear; all thiol-functional polyurethane-containing base coats were softer and felt-tacky, whereas-the hydroxyl-functional polyurethane-containing base coats were touch-dry.

Subsequently, a clear coat composition, Autoclear LV420, was applied on all six panels using a Devilbiss 1.4 F conventional spray gun. The clear coat Was also applied with increasing layer thickness (up to 66 μm). The clear coat was cured as specified in the technical information sheet (30 minutes at 60° C.). After good through cure (7 days at room temperature) the Persoz hardness of the panels was measured. All panels were measured at more or less the same layer thickness (for base coat and clear coat). The results are given in Table 5.

TABLE 5
Persoz hardness of coating systems comprising colored water
borne base coat compositions 19 to 24

| Base coat | | | | | | |
|---|---|---|---|---|---|---|
| composition/ | | | | | | |
| Example | 25 | 26 | 27 | 28 | 29 | 30 |
| Binder system | SH | SH | SH | OH | OH | OH |
| | based | based | based | based | based | based |
| | (19) | (20) | (21) | (22) | (23) | (24) |
| Layer thickness of | 10 | 18 | 18 | 14 | 16 | 19 |
| base coat (μm) | | | | | | |
| Layer thickness of | 59 | 50 | 54 | 55 | 58 | 52 |
| clear coat (μm) | | | | | | |
| Persoz hardness | 185 | 192 | 197 | 162 | 152 | 164 |
| (sec) | | | | | | |

### Examples 31 to 33 and Comparative Examples 34 to 36

Preparation of Solvent Borne Pigmented Base Coat Compositions 31 to 33 and Comparative Solvent Borne Pigmented Base Coat Compositions 34 to 36.

A number of solvent borne base coats were prepared as outlined in Table 6. All amounts are in grams.

TABLE 6
Preparation of solvent borne base coat compositions

| Composition | 31 | 32 | 33 | 34 | 35 | 36 |
|---|---|---|---|---|---|---|
| Green pigment* | 14.97 | | | 14.26 | | |
| Yellow pigment* | | 20.39 | | | 19.62 | |
| Red pigment* | | | 15.98 | | | 15.21 |
| CAB | 28.04 | 28.57 | 32.35 | 27.14 | 27.89 | 31.25 |
| PAPO | 20.60 | 20.93 | 24.03 | 19.93 | 21.84 | 23.21 |
| PE | | | | 12.82 | 10.41 | 13.27 |
| Penta(SH)4 | 9.39 | 7.60 | 9.74 | | | |
| Additive/solvent | 50.95 | 61.01 | 56.41 | 50.35 | 60.15 | 55.56 |
| mixture** | | | | | | |

*Green pigment is Monastral green 6y-c ex Avecia
*Yellow pigment is Paliotol Yellow L2140HD ex BASF
*Red pigment is Irgazin DPP Red Bo ex Ciba
**The additive/solvent mixture is a mixture comprising thinner 123 fast and optionally conventional paint additives

### Examples 37 to 39 and Comparative Examples 40 to 42

Use of Solvent Borne Base Coat Composition 31 to 33 and Comparative Solvent Borne Base Coat Compositions 34 to 36 in Coating Systems for Knoop Hardness Determination

Base coat compositions 31 to 36 were sprayed on a steel substrate, provided with sanded 3110 filler, in two layers, in each case followed by a drying step. Subsequently a clear coat was sprayed thereon. The clear coat-composition was Autoclear LV 420. On the panels the Knoop hardness was determined.

TABLE 7
Knoop hardness of coating systems comprising solvent borne base
coat compositions 31 to 36

| | | Knoop hardness |
|---|---|---|
| Example | Base coat comp. | (kg/mm²) |
| 37 | 31 | 4.04 |
| 38 | 32 | 3.50 |
| 39 | 33 | 2.87 |
| 40 | 34 | 2.50 |
| 41 | 35 | 2.48 |
| 42 | 36 | 2.78 |

### Examples 43 to 48 and Comparative Examples 49 to 54

Use of Solvent Borne Base Coat Compositions 31 to 33 and Comparative Solvent Borne Base Coat Compositions 34 to 36 in Coating Systems for Persoz Hardness Determination

Base coat compositions 31 to 36 were each sprayed on two steel panels provided with sanded 3110 filler, in two layers, in each case followed by a drying step. Subsequently, a clear coat layer selected from Autoclear LV 420 and Autoclear MS2000 was sprayed on the base coat. On the panels the Persoz hardness was determined after 1 day, 7 days, and 19 days. The Persoz hardness was determined in accordance with ISO 1522, except that the substrate was not glass plate but steel plate. The results are given in Table 8.

TABLE 8
Persoz hardness of coating systems comprising a solvent
borne base coat composition 31 to 36

| | | | Persoz | Persoz | Persoz |
|---|---|---|---|---|---|
| | | | hardness | hardness | hardness |
| Example | Base coat | Clear coat | day 1 | day 7 | day 19 |
| 43 | 31 | LV420 | 23 | 45 | 77 |
| 44 | 32 | LV420 | 23 | 42 | 65 |
| 45 | 33 | LV420 | 20 | 37 | 61 |
| 46 | 31 | MS2000 | 34 | 60 | 96 |
| 47 | 32 | MS2000 | 32 | 54 | 77 |
| 48 | 33 | MS2000 | 29 | 48 | 64 |
| 49 | 34 | LV420 | 20 | 34 | 51 |
| 50 | 35 | LV420 | 19 | 31 | 45 |
| 51 | 36 | LV420 | 18 | 31 | 47 |
| 52 | 34 | MS2000 | 30 | 56 | 69 |
| 53 | 35 | MS2000 | 31 | 53 | 64 |
| 54 | 36 | MS2000 | 27 | 49 | 63 |

An improved hardness build-up was found. The effect is most clearly visible when using the high solids clear coat LV 420.

### Examples 55 to 60 and Comparative Examples 61 to 66.

Use of Solvent Borne Base Coat Compositions 31 to 33 and Comparative Solvent Borne Base Coat Compositions 34 to 36 in Coating Systems for Adhesion Determination

Base coat compositions 31 to 36 were each sprayed on two steel panels provided with a sanded 3110 filler, in two layers, in each case followed by a drying step. Subsequently, a clear coat layer selected from Autoclear LV 420 and Autoclear MS2000 was sprayed on the base coat. On the panels the adhesion was determined after 1 day, 7 days, and 19 days. The results are given in Table 9. The abbreviations bc and bb mean that adhesion failure occurs on the base coat-clear coat boundary and within the base coat, respectively.

TABLE 9
Adhesion results of coating systems comprising solvent
borne base coat compositions 31 to 36

| | | | Adhesion | Adhesion | Adhesion |
|---|---|---|---|---|---|
| Example | Bast coat | Clear coat | day 1 | day 7 | day 19 |
| 55 | 31 | LV420 | 10 | 10 | 10 |
| 56 | 32 | LV420 | 9 bc | 5 bb | 2 bb/bc |
| 57 | 33 | LV420 | 10 | 10 | 9 |
| 58 | 31 | MS2000 | 10 | 10 | 10 |
| 59 | 32 | MS2000 | 10 | 10 | 10 |
| 60 | 33 | MS2000 | 10 | 10 | 10 |
| 61 | 34 | LV420 | 10 | 6 bc | 1 bc |
| 62 | 35 | LV420 | 10 | 2 bc | 1 bc |
| 63 | 36 | LV420 | 10 | 9 | 2 bc |
| 64 | 34 | MS2000 | 10 | 10 | 9 bc |
| 65 | 35 | MS2000 | 10 | 2 bc | 1 bc |
| 66 | 36 | MS2000 | 10 | 10 | 10 |

As shown by the examples above, improved Knoop hardness, Persoz hardness, and interlayer adhesion are obtained with base coats where the hydroxyl-functional polyester is replaced by a thiol-functional compound. The improvement in adhesion is most clearly visible when using the high solids clear coat Autoclear LV 420.

1. A multilayer coating system comprising
at least one layer a) comprising a coating composition a) comprising at least one resin and an effective number of thiol groups, and.
at least one layer b) comprising a coating composition b) comprising at least one resin and an effective number of thiol-reactive groups,
at least one layer a) and at least one layer b) having at least one common layer boundary.

2. A coating system according to claim 1 wherein in composition a) the thiol groups are covalently attached to said at least one resin.

3. A coating system according to claim 1 wherein composition a) comprises at least one resin and a compound comprising said thiol groups.

4. A coating system according to claim 2 wherein composition a) comprises at least a second resin.

5. A coating system according to claim 1 wherein the thiol-reactive groups are selected from the group of isocyanate groups, epoxy groups, Michael acceptor groups, electron rich carbon-carbon double bond-containing groups, acetal groups, carboxyl groups, ester groups, amide groups, cyclocarbonate groups, alkoxy silane groups, etherified amino groups, lactone groups, lactam groups, (cyclic) ketone groups, aldehyde groups, (cyclic) ketene acetal groups, carbodiimide groups, and thiol groups.

6. A coating system according to claim 5 wherein the thiol-reactive groups are, isocyanate groups.

7. A coating system according to claim 1 wherein in composition b) the thiol-reactive groups are covalently attached to said at least one resin.

8. A coating system according to claim 1 wherein composition b) comprises at least one resin and a compound comprising thiol-reactive groups.

9. A coating system according to claim 7 wherein composition b) comprises at least a second resin.

10. A coating system according to claim 1 wherein composition b) is a 2-component composition and comprises a component (i) which comprises thiol-reactive groups and a second component (ii) comprising groups which are reactive with thiol-reactive groups.

11. A coating system according to claim 1 wherein composition a) and/or composition b) in addition comprises at least one catalyst for the reaction between thiol-reactive groups and thiol groups.

12. A coating system according to claim 11 wherein said catalyst is a basic neutralizing agent.

13. A coating system according to claim 11 wherein the catalyst is a latent catalyst.

14. A coating system according to claim 13 wherein the latent catalyst is a photo-activatable catalyst.

15. A coating system according to claim 1 wherein coating composition a) comprises a curing agent comprising thiol-reactive groups and wherein the molar ratio of these thiol-reactive groups and thiol groups present in coating composition a) is below 0.5.

16. A coating system according to claim 1 wherein coating composition a) does not comprise a combination of a curing agent comprising thiol-reactive groups and a photo-activatable catalyst.

17. A coating system according to claim 1 wherein at least one of the coating compositions a) and/or b) is solvent borne.

18. A coating system according to claim 17 wherein coating composition a) is solvent borne and comprises a polyacrylate resin, a polyester resin, a cellulose compound, and a thiol-functional compound.

19. A coating system according to claim 1 wherein at least one of the coating compositions a) and/or b) is water borne.

20. A coating system according to claim 19 wherein coating composition a) is water borne and comprises a thiol-functional polyurethane resin and a polyacrylate dispersion.

21. A coating system according to claim 1 wherein the coating system is a base coat/clear coat system.

22. A method for finishing or refinishing an automobile or large transportation vehicle, comprising applying a coating system according to claim 1.

23. An aqueous coating composition comprising a thiol-containing polyurethane and a polyacrylate dispersion.
